(19) United States
(12) Patent Application Publication
(10) Pub. No.: US 2013/0052109 A1
(43) Pub. Date: Feb. 28, 2013

(54) COMPOSITIONS FOR ABSORBING CARBON DIOXIDE, AND RELATED PROCESSES AND SYSTEMS

(71) Applicants: Jason Louis Davis, Albany, NY (US); Robert James Perry, Niskayuna, NY (US)

(72) Inventors: Jason Louis Davis, Albany, NY (US); Robert James Perry, Niskayuna, NY (US)

(73) Assignee: GENERAL ELECTRIC COMPANY, Schenectady, NY (US)

(21) Appl. No.: 13/217,408

(22) Filed: Aug. 25, 2011

(51) Int. Cl. B01D 53/62; C09K 3/00

(52) U.S. Cl. 423/220; 252/184

(57) ABSTRACT

A carbon dioxide absorbent is disclosed. The absorbent compostion contains a liquid, non-aqueous, silicon-based material, functionalized with one or more groups that reversibly react with CO₂ and/or have a high-affinity for CO₂; and at least one amino alcohol compound. A method for reducing the amount of carbon dioxide in a process stream is also described. The method includes the step of contacting the stream with the carbon dioxide absorbent composition. A power plant that includes a carbon dioxide removal unit based on the carbon dioxide absorbent is also described.

The present application claims the benefit, under 35 U.S.C. 120, of pending application Ser. No. 12/512,105 (Robert J. Perry et al;), filed on Jul. 30, 2009; and Ser. No. 12/512,577 (Robert J. Perry et al), filed Jul. 30, 2009. The contents of each of these pending applications are incorporated by reference herein.

### BACKGROUND

This invention generally relates to processes for capturing carbon dioxide (CO₂) from gas streams.

The emission of carbon dioxide into the atmosphere from industrial sources such as power plants is now considered to be a principal cause of the “greenhouse effect”, which contributes to global warming. In response, tremendous efforts are underway to reduce emissions of CO₂. Many different processes have been developed to attempt to accomplish this task. Examples include polymer and inorganic membrane permeation; removal of CO₂ by adsorbents such as molecular sieves; cryogenic separation; and scrubbing with a solvent that is chemically reactive with CO₂, or which has a physical affinity for the gas.

One technique has received much attention for removing CO₂ from flue gas streams, e.g., exhaust gas produced at power plants. In this technique, aqueous monoethanolamine (MEA) or aqueous solutions of hindered amines like methyldiethanolamine (MDEA) and 2-amino-2-methyl-1-propanol (AMP) are employed as the solvents in an absorption/stripping type of regenerative process. The technique has been used commercially for CO₂ capture from coal fired power plants and gas turbines.

There are certainly considerable advantages inherent in the MEA and hindered amine-based absorption processes. However, a number of deficiencies may be preventing wider adoption of this type of technology. For example, the process can sometimes result in sharp increases in the viscosity of the liquid absorbent, which can cause clogging of pipelines. To avoid this problem, the concentration of MEA and other amines is sometimes maintained at a relatively low level, e.g., below about 30 wt. % in the case of MEA. However, the lower concentrations can greatly reduce absorbing capacity, as compared to the theoretical capacity of the neat absorbent.

Moreover, energy consumption in the MEA process can be quite high, due in large part to the need for solvent (e.g., water) heating and evaporation. For example, the process may consume about 10-30% of the steam generated in a boiler that is heated by combustion of a fossil fuel. Furthermore, MEA-based absorption systems may not have the long-term thermal stability, in the presence of oxygen, in environments where regeneration temperatures typically reach at least about 120° C.

Additional drawbacks may result from the fact that the liquid absorbent which is enriched with CO₂ in the MEA or hindered amine process may still contain a substantial amount of free amine and solvent (usually water). The amine and water are usually removed in the vapor phase under thermal desorption, but can cause corrosion and other degradation in the attendant equipment. To address this concern, specialized, corrosion-equipment materials can be used for the equipment, but this can in turn increase capital costs for the plant. In some cases, corrosion inhibitors can be added, but the use of these specialized additives can also increase operational costs. Moreover, the oxidation of the MEA or hindered amine absorbents can acidify some of the solvents present. In addition to the corrosion problems which can result, this may decrease the available alkalinity for CO₂ capture, thereby reducing process efficiency.

Another example of a commercial CO₂ post-combustion capture process uses aqueous solutions of piperazine-promoted potassium carbonate (K₂CO₃). However, this process is often very energy-intensive, and can be economically inferior to the MEA process. Still another example involves the use of chilled ammonia. In this case, energy-intensive cooling systems are usually required for such a system, and the risks associated with unintended ammonia release may be unacceptable.

Other CO₂ capture processes of considerable interest call for the use of amino-siloxane materials, as described in a U.S. patent application for Perry et al; Ser. No. 12/512,105, filed on Jul. 30, 2009. These materials are capable of reacting with gaseous CO₂ to form the solid material, as described herein. The siloxane materials are often used in conjunction with hydroxy-containing solvents, such as one or more glycol-based materials.

CO₂ capture systems using aminosiloxane materials or other capture agents are susceptible to a number of other conflicting requirements, in terms of materials and operation. This is especially true in the case of the large-scale, industrial capture of the gas. One illustration relates to the viscosity property mentioned previously. CO₂ absorbents usually have to be fairly high-molecular weight materials, to ensure relatively low volatility. However, as molecular weight is increased, the absorbent can dramatically increase in viscosity, especially after pick-up of the gas. Such a phenomenon can lead to serious mass transfer limitations in a large-scale system. Moreover, in order to provide high CO₂ capacity at low pressures, the overall heat-of-reaction for the reaction system needs to be relatively high. However, in order to also ensure a practical, low regeneration energy level, the overall heat-of-reaction needs to be relatively low.

In view of the discussion above, one can understand the need for new CO₂ capture technology that optimizes as many of the above desired properties as possible, without causing substantial detriment to other desired properties. At a minimum, in order to be commercially viable, such technology would desirably be utilized at a relatively low cost, and would also utilize materials(s) having low volatility, low viscosity, acceptable thermal stability, and a relatively high net capacity for CO₂. Moreover, the processes should be compatible with related systems, e.g., power generation systems based on gasification, combustion, and the like.

### BRIEF DESCRIPTION OF THE INVENTION

One embodiment of this invention is directed to a carbon dioxide absorbent, comprising
a) a liquid, non-aqueous, silicon-based material, functionalized with one or more groups that reversibly react with CO₂ and/or have a high-affinity for CO₂; and
b) at least one amino alcohol compound.

Another embodiment of the invention is directed to a method for reducing the amount of carbon dioxide in a process stream, comprising the step of contacting the stream with a carbon dioxide absorbent, as mentioned above, and further described in the remainder of this disclosure.

A power plant comprising a carbon dioxide removal unit that contains the carbon dioxide absorbent represents yet another embodiment of this invention.

Still another embodiment is directed to a method of generating electricity with reduced carbon dioxide emissions, comprising the step of combusting a fuel to produce an exhaust gas that contains carbon dioxide; and directing the exhaust gas to a gas removal unit that contains the carbon dioxide absorbent described herein.

### BRIEF DESCRIPTION OF THE DRAWINGS

FIG. 1 is a graph, depicting both CO₂— uptake and viscosity, as a function of the proportions of siloxane and amine constituents in the CO₂ absorber compositions described herein.

### DETAILED DESCRIPTION OF THE INVENTION

The compositional ranges disclosed herein are inclusive and combinable (e.g., ranges of “up to about 25 wt %”, or, more specifically, “about 5 w t % to about 20 wt %”, are inclusive of the endpoints and all intermediate values of the ranges). Weight levels are provided on the basis of the weight of the entire composition, unless otherwise specified; and ratios are also provided on a weight basis. Moreover, the term “combination” is inclusive of blends, mixtures, alloys, reaction products, and the like. Furthermore, the terms “first,” “second,” and the like, herein do not denote any order, quantity, or importance, but rather are used to distinguish one element from another. The terms “a” and “an” herein do not denote a limitation of quantity, but rather denote the presence of at least one of the referenced items.

The modifier “about” used in connection with a quantity is inclusive of the stated value, and has the meaning dictated by context, (e.g., includes the degree of error associated with measurement of the particular quantity). The suffix “(s)” as used herein is intended to include both the singular and the plural of the term that it modifies, thereby including one or more of that term (e.g., “the compound” may include one or more compounds, unless otherwise specified). Reference throughout the specification to “one embodiment”, “another embodiment”, “an embodiment”, and so forth, means that a particular element (e.g., feature, structure, and/or characteristic) described in connection with the embodiment is included in at least one embodiment described herein, and may or may not be present in other embodiments. In addition, it is to be understood that the described inventive features may be combined in any suitable manner in the various embodiments.

As further described herein, carbon dioxide is present in a wide variety of gas streams which can be treated according to embodiments of this invention. Non-limiting examples include gas streams originating from a combustion process; a gasification process; a landfill; a furnace (e.g., blast furnace or chemical reduction furnace); a steam generator; a boiler; and combinations thereof. In some embodiments, the CO₂ gas stream is a flue stream originating in a coal-fired power plant. In other embodiments, the CO₂ gas stream originates in a coal gasification plant, exemplified by an integrated gasification combined cycle (IGCC) plant. In addition to CO₂, the flue stream can include a number of other constituents, such as oxygen, nitrogen, argon, carbon monoxide, nitrogen oxygen compounds, sulfur compounds (e.g., sulfur dioxide, carbonyl sulfide); soot particles, and water vapor.

As mentioned above, the carbon dioxide absorbent comprises a liquid, nonaqueous silicon-based material. “Silicon-based materials” are defined as molecules having between one and twenty repeat units, and thus, may include small molecules comprising silicon, i.e., molecules comprising from one to five silicon atoms, or oligomeric materials comprising between about 5 and 20 silicon atoms.

Of these materials, silicones are particularly well-suited for use in the present absorbents. Also correctly referred to as polymerized “siloxanes” or “polysiloxanes”, silicones are mixed inorganic-organic polymers or oligomers with the chemical formula [R₂SiO]ₙ, wherein R comprises a linear, branched or aromatic organic group of any number of carbons, e.g., methyl, ethyl, phenyl, and the like. These materials thus comprise an inorganic silicon-oxygen backbone ( . . . Si—O—Si—O—Si—O— . . . ) with organic side groups attached to the silicon atoms, which are four-coordinate. These silicones may be linear with R and OR′ end-capping groups, or cyclic groups, containing only repeating units. An example of the latter is octamethyl-cyclotetrasiloxane.

Silicones have low volatility, even at short chain lengths; and are usually liquids at room temperature. They are typically low cost, and stable at high temperatures, e.g., up to about 150° C. Silicones are also readily functionalized, and so, could be functionalized with groups that increase their affinity for CO₂, as further described below.

The length of the silicone oligomer chain can be easily controlled during synthesis, thereby allowing control of such physical properties as viscosity and boiling point. In addition, siloxane bonds are thermally stable and hydrolytically stable in the absence of strong acids or bases. Many silicone precursors are commercially available, and so advantageously, large scale production capabilities would not have to be developed. Many of these may be utilized in the present invention. One example of a silicone suitable for functionalization in the present invention, and available from a variety of sources, comprises polyhydridomethylsiloxane.

In another embodiment, the present absorbent comprises a CO₂-philic, silicon-based small molecule, e.g., comprising from about one to about five silicon atoms. As used herein, the term “CO₂-philic, silicon-based small molecule” means a material that reversibly reacts with or has an affinity for CO₂. (As further described below, the silicon-based materials usually contain one or more siloxy units).

In some embodiments, the silicon-based small molecules comprise one silicon atom as shown in Formula (I), wherein L=a linking group of C₁-C₁₈, and may be aliphatic, aromatic, heteroaliphatic, heteroaromatic or mixtures thereof:

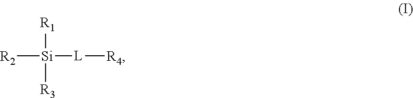

and where R₁, R₂, R₃ may be the same or different, and may be C₁-C₁₈ aliphatic, aromatic, heteroaliphatic, heteroaromatic or mixtures thereof. R₄ can be equal to NR₅R₆, where at least one of R₅ or R₆ is hydrogen (H). The other (of R₅ or R₆) may be C₁-C₁₈ aliphatic, aromatic, heteroaliphatic, heteroaromatic or mixtures thereof.

In other embodiments, the silicon-based molecule may include more than one silicon atom; or can include repeating units, each with at least one silicon atom. Formulae II-VI (as shown below) are illustrative. With reference to those materials, when x≦5, y+z≦5 and/or r≦5, silicon-based materials represented by formulae II-VI would generally be considered silicon based small molecules. Moreover, when x≧5, y+z≧5 and/or r≧5, silicon based materials represented by formulae II-VI would generally be considered silicon-containing oligomers. As depicted in structures II-VI, the core of the silicon-based small molecule may be linear, cyclic, branched or combinations of these configurations.

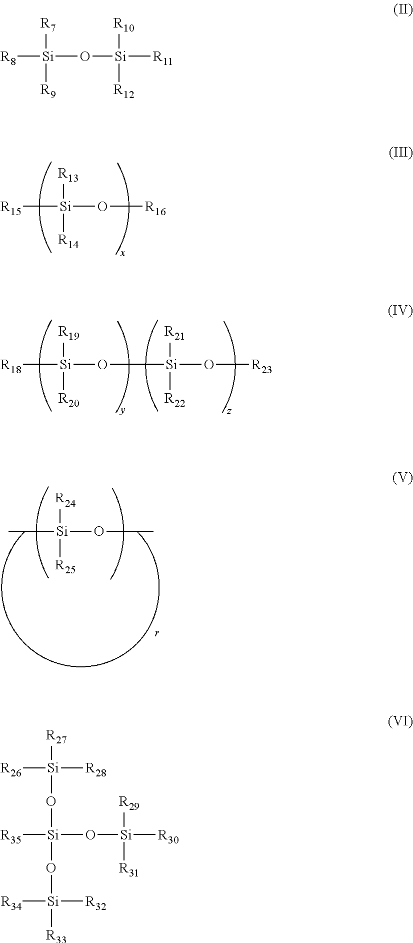

For Formula II, R₇-R₁₂ may be the same or different. At least one of R₇-R₁₂ will desirably be L-R₄, while the remainder are usually C₁-C₁₈ aliphatic, aromatic, heteroaliphatic, heteroaromatic or mixtures thereof.

For formula III, R₁₃-R₁₆ may be the same or different. At least one of R₁₃-R₁₆ will preferably be L-R₄ (as described above), while the remainder are preferably C₁-C₁₈ aliphatic, aromatic, heteroaliphatic, heteroaromatic or mixtures thereof. R₁₆ is usually SiRR′R″, wherein R, R′ and R″ may be the same or different, and may be C₁-C₁₈ aliphatic, aromatic, heteroaliphatic, heteroaromatic or mixtures thereof. R₁₆ can also be L-R₄, wherein L and R₄ are as defined above.

For the formulae IV, V, and VI, R₁₈-R₂₃, R₂₄-R₂₅, and R₂₆-R₃₅ may be the same or different; and at least one of R₁₈-R₂₃ is L-R₄. At least one of R₂₄-R₂₅ can be an L-R₄ group—different from, or the same as, any of the other L-R₄ groups in the particular formula. At least one of R₂₆-R₃₅ can also be an L-R₄ group, and the rest may be C₁-C₁₈ aliphatic, aromatic, heteroaliphatic, heteroaromatic or mixtures thereof. In these cases, R₂₃ can be SiRR′R″, wherein R, R′ and R″ may be the same or different, and may be C₁-C₁₈ aliphatic, aromatic, heteroaliphatic, heteroaromatic, or mixtures thereof, or may be L-R₄.

The silicon-based material may desirably be functionalized with groups that enhance its net capacity for CO₂. Functional groups that are expected to be CO₂-philic, and react with CO₂ in a silicon-based material they functionalize, are preferred. Many of these materials are nitrogen-containing groups. Examples of such groups are those including nitrogen, such as primary or secondary aliphatic or aromatic amines, imines, amidines, heterocyclic amino compounds such as imidazole, aromatic amines such as aniline, and the like, as well as combinations of any of these.

The particular functional group utilized will depend upon the silicon-based material chosen. For those embodiments wherein the silicon-based material comprises a siloxane, an amine functionality may be suitable, since many amino siloxanes are readily commercially available, and are readily further functionalized if desired or required in order to increase CO₂ reactivity. In some preferred embodiments, the functional group comprises at least one primary aliphatic amine, diamine, triamine, or polyamine.

Some specific examples of amine-functional groups that exhibit CO₂-reactivity include aminomethyl, aminoethyl, aminopropyl, aminobutyl, aminoisobutyl, aminoethylaminopropyl; 4-methylaminobutyl; 4,4-dimethylaminobutyl; 3-(2-amino butyl)aminopropyl; 2,2-bis(aminomethyl)butyl; 4,4-bis(aminomethyl)hexyl; 4,4-bis(aminomethyl)butyl; piperazinopropyl; aminoethylaminomethyl groups, or combinations of such groups.

Many of the functional groups for the silicon-based material may be located on a side chain. They may also be present as end-capping groups. Formula VII, below, provides an example of aminoethyl-aminopropyl siloxane oligomers with functional groups in the side chain. This molecule has a maximum theoretical CO₂ capacity of about 20 wt %, compared to 10 wt % for 30 wt % aqueous monoethanolamine (MEA).

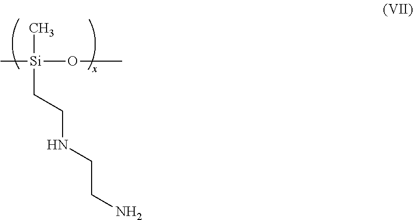

Another example of an aminosiloxane with end-capped functional groups suitable for use in the absorbent composition is an aminopropyl-terminated polydimethylsiloxane, e.g., 1,5-bis-(3-aminopropyl)hexamethyl-trisiloxane (“GAP-1”), shown below in Figure VIII:

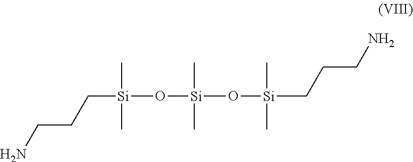 [SMILES: C[Si](C)(CCCN)O[Si](C)(C)O[Si](C)(C)CCCN]

One such aminosiloxane is commercially available from Gelest, with a number average molecular weight of from about 300 to about 350, and a calculated CO₂ absorption capacity of about 13.7 wt %. It is expected that the addition of further amine functionality will result in an increase in this absorption capacity.

In some specific embodiments for carbon capture systems, especially larger, industrial-scale systems, the functionalized silicon-based material may comprise linear, branched, star or cyclic aminopropyl-, aminobutyl- or aminoisobutyl-substituted siloxanes. These siloxanes preferably include non-reactive groups on the silicon-based material, e.g., C₁-C₆ alkyl or phenyl groups. The total molecular weight of these silicon-based materials is usually less than about 2000 Daltons.

Those of ordinary skill in the art of polymer chemistry are well versed in techniques for adding functional groups to the backbone of an oligomer useful in the presently-described CO₂ absorbent. Numerous methods of attachment of functional groups are known. Examples include hydrosilylation and displacement, as shown in Michael A. Brook's book Silicon in Organic, Organometallic, and Polymer Chemistry (Wiley VCH Press, 2000).

As mentioned above, the carbon dioxide absorbent of this invention further comprises at least one amino alcohol compound. A variety of these compounds may be used, as described below. (They are sometimes referred to herein as “co-solvents” with the functionalized silicon material). In some specific embodiments, the amino alcohol has a boiling point greater than about 90° C., thereby having less of a tendency to be volatile, and to be lost from the overall system during operation. In some preferred embodiments, the amino alcohol has a boiling point greater than about 180° C.

As also alluded to previously, the amino alcohol compound should have a viscosity low enough (in admixture with the silicon-based material) to allow the overall absorbent composition to be transported relatively easily through the gas capture system, under operational temperatures. In some specific embodiments, the amino alcohol has a viscosity less than about 200 cP, at 40° C. In many preferred embodiments, the viscosity is less than about 50 cP. Those skilled in the art will be able to determine the ideal viscosity for a particular gas-capture system, based on many of the factors described herein.

In general, the amino alcohol can be one or more compounds selected from a variety of families. Examples include

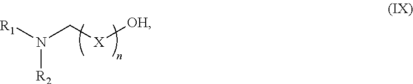

wherein X can be carbon (C), nitrogen (N), oxygen (O), sulfur (S), or silicon (Si); or can be a linking group containing such atoms; and wherein n is 1 to 5 (and wherein all of the R groups are as defined below);

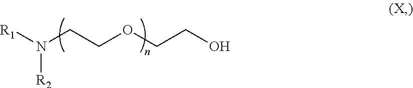

wherein n is 1 to 5;

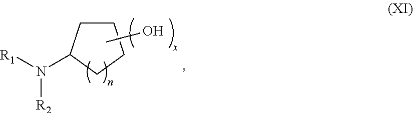

wherein n is 1 to 3; and x is 1 to 3;

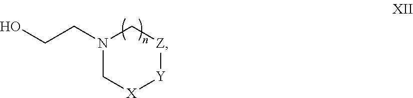

wherein X can be C, N, O, S, or Si (or a linking group containing such an atom); Y can be C, N, O, S, or Si; and Z can be C, N, O, S, or Si; and n is 0 to 3;

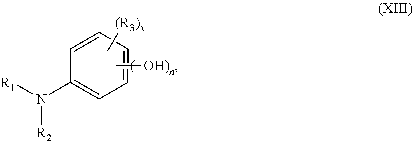

wherein n is 1 to 3; and x is 1 to 3; and

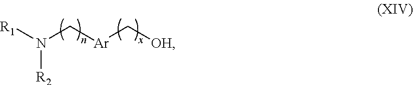

wherein n is 1 to 5; x is 0 to 3; and “Ar” is a phenyl group, cycloalkyl group, heterocycloalkyl group; or heteroaryl group.

For each of formulae IX to XIV, R₁, R₂, and R₃ can be, independently, C₁-C₆ alkyl, C₂-C₆ alkenyl, C₃-C₇ cycloalkyl, phenyl, heterocycloalkyl; or a 5- or 6-membered heteroaryl group, each of which may optionally be substituted with hydroxyl groups.

In some embodiments, the amino alcohol compound preferably has the formula

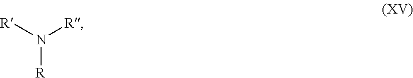

wherein each of R, R′, and R″ is independently hydrogen; a straight or branched chain aliphatic group containing about 2 to about 8 carbon atoms in a main chain; phenyl, cycloalkyl, heterocyclo alkyl, or heteroaryl;

but wherein at least one of R, R′, and R″ contains at least one hydroxy group.

In the case of formula (XV), the amino alcohol is often (though not always) a tertiary amine, in which each of R, R′, and R″ is an aliphatic group. The chain length of the aliphatic group (i.e., the longest straight chain attached to the nitrogen group) is usually about 2 to 5 carbon atoms.

Non-limiting examples of amino alcohols that can be used for embodiments of the invention are: diethanolamine, triethanolamine, tripropanolamine, dimethylethanolamine, methyldiethanolamine, diethylethanolamine; di-(3-hydroxylpropyl)amine; N-tri(3-hydroxylbutyl)amine; N-tri-(4-hydroxylbutyl)amine; N,N-tri-(2-hydroxylpropyl)amine; N,N-diisopropylethanolamine; N,N-diethylpropanolamine; N,N-diethyl-(2,3-dihydroxypropyl)amine; N-ethyldiethanolamine; and N-propyldiethanolamine.

The proportion of the functionalized silicon-based material (component (a)) and the amino alcohol (component (b)) will depend on a variety of factors. Some of the factors are: the chemical composition and properties of each component (as well as their cost); the process details for the overall CO₂ capture system; the amount of CO₂ to be captured; and the manner in which the CO₂ will later be released from the absorbent.

In general, the variation of the proportion of the components results in varying degrees of viscosity and volatility. In some embodiments, the ratio of component (a) to component (b) is sufficient to provide a carbon dioxide absorbent that has a boiling point of greater than about 90° C.; and a viscosity of less than about 10,000 cP, during at least one operating cycle in which the absorbent is used. This illustration assumes an operating cycle in a temperature range of about 25° C. to about 200° C. On a general note, it may be preferable in some cases if the overall viscosity of the absorbent material is less than about 5,000 cP, as measured at 40° C.°; and in other embodiments, less than about 1,000 cP.

In some specific embodiments, the ratio (by weight) of the functionalized silicon-based material (component (a)) to the amino alcohol (component (b)) is in the range of about 20:80 to about 80:20. (These values are based on the total amount of each component present). In some preferred embodiments, the ratio is about 40:60 to about 60:40. Those skilled in the art will be able to determine the most appropriate ratio of components for a given situation, based on the teachings provided herein.

It should also be noted that components (a) and (b) are usually present as a physical mixture. In other words, in the preparation and use of the CO₂ absorbent, there is substantially no copolymerization between the two components. In some circumstances, the absence of copolymerization is advantageous because it provides much greater flexibility in optimizing the ratio of the two components, for a given application.

In some end use applications, particular groups of amines and siloxane materials may be preferred for use, based on many of the considerations discussed herein. The amines include, for example:

NR₁R₂R₃, where R₁ can be a methyl, ethyl, propyl, or isopropyl group; and R₂ and R₃ can independently be ethanol or propanol groups (with N-methyl diethanolamine being especially preferred in some instances);

NR₁R₂R₃, where R₁ and R₂ can, independently, be a methyl, ethyl, propyl, or isopropyl group; and R₃ can be an ethanol or a propanol group; and

triethanol amine.

The preferred siloxanes are often 1,3-bis-(3-aminopropyl)tetramethyldisiloxane (“GAP-0”); and 1,5-bis-(3-aminopropyl)hexamethyl-trisiloxane (“GAP-1”).

In some embodiments, the carbon dioxide absorbent may comprise an amount of water. For example, all of the water that is present in the process stream does not have to be removed from the process stream in order to utilize the absorbent and methods. In fact, in some embodiments, water is desirably present, and can assist in the solubilization of reaction products.

The carbon dioxide absorbent composition described herein may also include other components and additives. Non-limiting examples include oxidation inhibitors (which can increase oxidative stability), anti-foaming agents, anti-static agents, antimicrobial agents, corrosion inhibitors, absorption catalysts, and desorption catalysts. The use of oxidation inhibitors, also called “antioxidants”, can be especially advantageous in those embodiments of the invention wherein the functional groups comprise amine groups.

As mentioned above, another embodiment of this invention is directed to a process for reducing the amount of carbon dioxide (CO₂) in a process stream. The process stream can represent any source that produces and/or emits CO₂, especially those sources that produce the gas in very large volumes. As an example, the process stream may be an exhaust gas stream from a combustion system or a gasification system, or combinations of any number of gas-producing systems. The process stream is typically gaseous, but may contain solid or liquid particles. Moreover, the process stream may may be present at a wide range of temperatures and pressures, depending on the source of the stream, e.g, a power plant that produces electricity. As described previously, the process includes the step of contacting the gas stream with a carbon dioxide absorbent that comprises components (a) and (b), as described above.

Those skilled in the art are familiar with a variety of CO₂ absorption systems that would be compatible with the presence and use of the CO₂ absorbents described herein. Some attention is directed to U.S. Pat. No. 4,112,051 (Sartori et al); and U.S. Pat. No. 7,892,324 (Frydman et al), both of which are incorporated herein by reference. EP Application 0,674,936 A2 (Starke et al) is also instructive in this regard.

Information regarding the incorporation of CO₂ capture units into various types of power plants, such as coal-fired plants, is also available from many sources. Non-limiting examples include “Carbon Dioxide Capture from Existing Coal-Fired Power Plants, DOE/NETL-401/110907”, Revision Date November 2007 (National Energy Technology Laboratory). (A Web-based version is available at http://www.netl.doe.gov/energy-analyses/pubs/CO2%20Retrofit%20From%20Existing%20Plants%20Revised%20November%202007.pdf). Another source with relevant information is “NETL—The Energy Lab”; Carbon Sequestration—Pre-Combustion Capture Focus Area, at http://www.netl.doe.gov/technologies/carbon_seq/corerd/precombustion.html, along with NETL links provided therein. Those skilled in the art will be able to utilize that information, along with information from many other sources, to supplement the primary teachings provided herein.

### EXAMPLES

The following examples illustrate methods and embodiments in accordance with the invention. Unless specified otherwise, all ingredients may be commercially available from such common chemical suppliers as Alpha Aesar, Inc. (Ward Hill, Mass.), Sigma Aldrich (St. Louis, Mo.), Spectrum Chemical Mfg. Corp. (Gardena, Calif.), Gelest (Morrisville, Pa.) and the like.

A general procedure for measuring CO₂ uptake for these examples is as follows: Samples of the amino siloxane/co-solvent blend were charged to a 100 mL three-necked flask; and the mass was determined using an analytical balance. The flask was equipped with an overhead stirrer, a CO₂ inlet terminating with a glass pipette aimed slightly above the surface of the liquid, and another tube connected to a bubbler filled with silicone oil. Each sample was heated to 40° C. (oil bath) for two hours with gentle stirring. The CO₂ flow was produced via charging 250-270 g of dry ice to a 1000 mL three necked-flask equipped with a stopper, a plastic tube connected through a drying tube (filled with blue Indicating Drierite) to the CO₂ inlet on the 100 mL flask, and finally a stopcock that was used to control the rate of gas flow through the test system. The rate was adjusted so that a steady stream of bubbles was observed in the bubbler. Care was taken to keep the flow from being excessive.

When the test was complete, the CO₂ flow was discontinued as was stirring. The sample was then cooled to room temperature; and the outside of the flask was wiped clean to remove any silicone oil remaining from the oil bath. After drying the outside of the flask, the combined weight of reaction vessel was determined, using an analytical balance. The weight gain was then compared to the theoretical weight gain, based on the amount of aminosiloxane charged; the number of amines per molecule; and the molecular weight of the material. It was assumed that two amines are required to react with each CO₂ molecule (MW=44.01), via the classic primary amine-CO₂ reaction.

The viscosity measurements were carried out according to the following procedure. A Cannon-Fenske viscometer was used. The fluid being measured was added to the appropriate tube, and allowed to come to 40.0° C. over 1 hr in a temperature controlled water bath. A series of three measurements were taken and the average value is reported.

### Example 1

### Synthesis of 1,3-bis(3-(2-aminoethyl)aminopropyl)-1,1,3,3-tetramethyldisiloxane (Entry 27 in Table 4, below)

Ethylenediamine (155 g, 2.58 moles) was charged to a 500 mL three-necked flask equipped with a magnetic stir bar, reflux condenser, addition funnel, and nitrogen sweep. The amine material was then heated, using an oil bath. Once the temperature reached about 95° C., 1,3-bis(3-chloropropyl)-1,1,3,3-tetramethyldisiloxane (73 g, 254 mmols) was added drop-wise over about 2 hours. During this time. the temperature of the oil bath was allowed to increase to about 110-115° C. Once addition was complete, the reaction mixture was allowed to continue at this temperature for 2 more hours, at which time proton NMR readings indicated that the reaction was complete.

The mixture was then cooled, and some of the excess ethylene diamine was stripped off. At this point, the material was cooled to room temperature, and partitioned between chloroform and 10% NaOH. The organic phase was then washed with deionized water and saturated sodium chloride, and dried over anhydrous potassium carbonate. After filtration, solvent was removed on a rotary evaporator, yielding 71.2 g (84%) of crude product, which was purified by fractional distillation at 130-135° C./0.18-0.25 mm Hg. ¹H NMR (CDCl₃) d: 2.79 (t, J=6.0 Hz, 4H); 2.65 (t, J=6.0 Hz, 4H); 2.58 (t, J=7.3 Hz, 4H); 1.49 (m, 4H); 1.31 (br 6H); 0.49 (m, 4H); 0.03 (s, 12H). ¹³C{¹H}NMR (CDCl₃): δ3.1, 52.7, 41.9, 23.9, 15.8, 0.3 ppm. FT-IR (neat): 3366, 3285, 2929, 2877, 2807, 1604, 1495, 1455, 1345, 1301, 1257, 1176, 1127, 1054, 841, 795 cm⁻¹.

### Example 2

### Synthesis of tris(3-aminopropyldimethylsiloxy)-3-aminopropylsilane (M′₃T′) (Entry 29 in Table 4, below)

42.1 g of GAP-0 (0.339 mols M′) was mixed with 25.0 g 3-aminopropyltriethoxysilane (0.113 mols), and 0.65 g of tetramethylammonium hydroxidepentahydrate. The solution was heated at 60° C. (under N₂) for an hour, and then 6.8 mL of water were added. Heating was then continued up to 90-95° C. 70 mL toluene was added, and after another hour a vacuum was applied and the toluene as well as water, and ethanol were stripped off. Once solvent stripping was complete, NMR showed the ethoxy groups to be essentially gone. Heating was continued overnight to ensure the reaction was at equilibrium. Then, the mixture was further heated and stripped as above (i.e. house vacuum, strip up to 165° C.). On cooling to room temperature, 53.8 g of material (98.5% yield) was obtained as a light yellow oil. ¹H NMR (CDCl₃) d 2.60 (t, J=6, 8H, CH₂NH₂), 1.39 (m, 8H, CH₂CH₂CH₂), 1.04 (br. s., 8H, NH₂), 0.46 (m, 8H, CH₂Si), 0.08 to −0.02 (m, 18.5H, CH₃Si).

### Example 3

### Synthesis of 1,5-bis(3-aminopropyl)-1,1,3,3,5,5-hexamethyltrisiloxane (sometimes referred to as “GAP-1”, entry 25 in Table 4, below)

20.0 g of GAP-0 (0.0805 mols) was mixed with 6.0 g D₄ (0.0805 mols D) and 0.15 g of tetramethyl-ammoniumhydroxide pentahydrate. The mixture was heated to ca. 40° C. under vacuum for an hour to remove some of the water from the catalyst. Next, a nitrogen atmosphere was established, and the temperature was increased to 90-95° C., and allowed to react overnight. The reaction mixture was then heated to 150° C. for 30 minutes. A vacuum was then carefully applied (house vacuum). Heating was then continued to 165° C., and the most volatiles species were stripped off. After cooling, ca. 25 g of product (96% yield) was obtained as a light yellow oil. ¹H NMR (CDCl₃) d 2.60 (t, J=6, 4H, CH₂NH₂), 1.39 (m, 4H, CH₂CH₂CH₂), 1.03 (br. s., 4H, NH₂), 0.45 (m, 4H, CH₂Si), 0.05 to −0.06 (m, 18.6H, CH₃Si).

### Example 4

### Synthesis of 1,3,5-tris(3-aminopropyl)-1,1,3,5,5-pentamethyltrisiloxane (M′D′M′, entry 28 in Table 4)

111.8 g of GAP-0 (0.404 mols) were mixed with 77.2 g 3-aminopropyl-methyldiethoxysilane (0.403 mols), and 1.5 g of tetramethylammonium hydroxide pentahydrate. Next, a nitrogen atmosphere was established, and the mixture was heated, using an oil bath. As the temperature reached approximately 60° C., 17 mLs water were added. Heating was continued and once the temperature reached ˜85-90° C., 160 mLs toluene were added. After an hour, a vacuum was carefully applied (ca 40 torr) and the toluene, excess water, and ethanol were distilled off.

After distillation of the volatile components was substantially complete, the vacuum was broken with nitrogen, and the reaction mixture was allowed to remain at 90-95° C. overnight. It was then heated to 150° C. for 30 minutes, to decompose the catalyst. A vacuum was then carefully applied. Heating was continued to an oil bath temperature of 170° C., during which time the volatiles were stripped off. After cooling, ca. 142 g of product (96% yield) was obtained as a light yellow oil. ¹H NMR (CDCl₃) d 2.57 (t, J=7, 6H), 1.36 (m, 6H), 1.01 (br. s., 6H), 0.41 (m, 6H), 0.02 to −0.08 (m, 15H).

Table 1, listing Examples 1-10, provides a summary of selected physical properties for some of the amino alcohols used in embodiments of this invention.

TABLE 1

| | | | Viscosity (cP @ |
|---|---|---|---|
| Example | Structure | Bp (° C.) | 40° C.) |
| 1 | 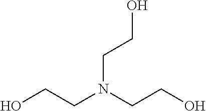 | 335 | 204 |
| 2 | 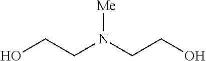 | 247 | 34 |
| 3 | 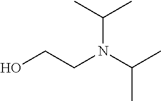 | 127 | 4 |
| 4 | 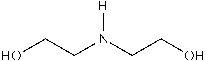 | 268 | 181 |
| 5 | 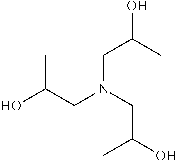 | 305 | solid |
| 6 | 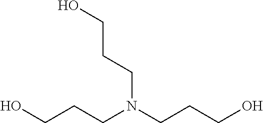 [SMILES: OCCCN(CCCO)CCCO] | 175-185/1 torr (360) | solid |
| 7 | 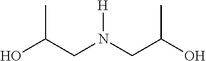 | 249 | solid |
| 8 | 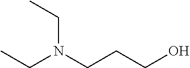 | 189 | 4 |
| 9 | 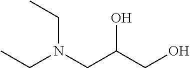 | 233 | 28 |
| 10 | 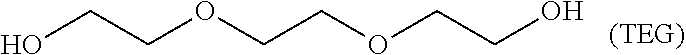 | 288 | 18 |

Table 2. listing examples 11-18 and comparative example 19, provides carbon dioxide absorbance (CO₂ “uptake”) and viscosity data for the samples of “GAP-0” carbamate, at 50 wt % in the amino alcohol compound.

TABLE 2

| | | | | | Carbamate |
|---|---|---|---|---|---|
| | | CO₂ | CO₂ Uptake | CO₂ | Solution |
| | | Uptake | (theoretical | Uptake (% | Viscosity (cP @ |
| Ex. # | Structure | (wt %) | wt %) | of theory) | 40° C.) |
| 11 | 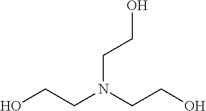 | 10.6 | 8.9 | 119 | 7270 |
| 12 | 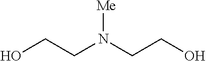 | 11.3 | 8.9 | 128 | 2506 |
| 13 | 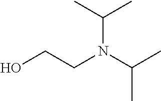 | 7.5 | 8.9 | 93 | 2836 |
| 14 | 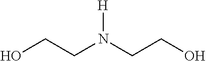 | 15.1 | 8.9 | 172 | 50,415 |
| 15 | 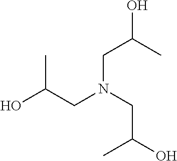 | 9.8 | 8.9 | 111 | 36,561 |
| 16 | 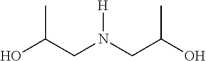 | 16.3 | 8.9 | 185 | 398,911 |
| 17 | 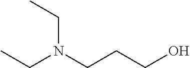 | 11.6 | 8.9 | 131 | 1221 |
| 18 | 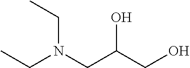 | 11.2 | 8.9 | 127 | 6410 |
| 19 | 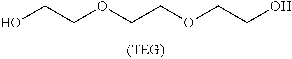 | 10.4 | 8.9 | 117 | 1267 |

Table 3. listing Examples 20-23, provides additional data regarding CO₂ capture when using the GAP-1 material, and 50 wt % amino alcohol, with sample 23 being used for comparison.

TABLE 3

| | | % CO₂ | Theoretical | % of | Viscosity |
|---|---|---|---|---|---|
| Ex. # | Amino Alcohol | absorbed | wt % | Theory | (cP) |
| 20 | 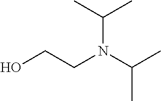 | 7.5 | 6.8 | 110 | 423 |
| 21 | 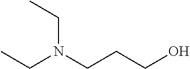 | 7.8 | 6.8 | 115 | 882 |
| 22 | 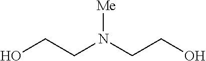 | 8.8 | 6.8 | 129 | 946 |
| 23 | 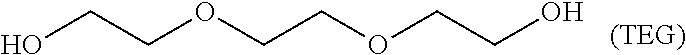 | 7.5 | 6.8 | 110 | 433 |

Table 4. listing Examples 24-29, provides data regarding CO₂ capture when using various amino silicones (i.e., the functionalized silicon-based material of this invention) with 50 wt % N-methyldiethanolamine.

TABLE 4

| | | % CO₂ | Theoretical | % of | Viscosity |
|---|---|---|---|---|---|
| Ex. # | Aminosilicone | absorbed | wt % | Theory | (cP) |
| 24 | 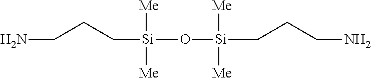 [SMILES: C[Si](C)(CCCN)O[Si](C)(C)CCCN] | 11.3 | 8.8 | 128 | 2,506 |
| 25 | 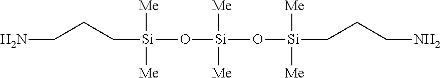 [SMILES: C[Si](C)(CCCN)O[Si](C)(C)O[Si](C)(C)CCCN] | 8.8 | 6.8 | 129 | 946 |
| 26 | 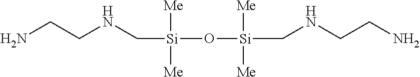 [SMILES: C[Si](C)(CNCCN)O[Si](C)(C)CNCCN] | 17.8 | 15.8 | 113 | 115,934 |
| 27 | 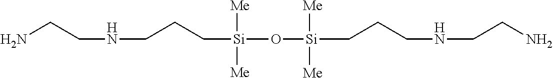 [SMILES: C[Si](C)(CCCNCCN)O[Si](C)(C)CCCNCCN] | 15.1 | 15.8 | 95 | 39,351 |
| 28 | 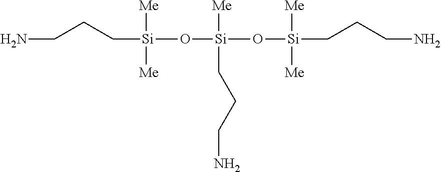 [SMILES: C[Si](C)(CCCN)O[Si](C)(CCCN)O[Si](C)(C)CCCN] | 11.4 | 9.0 | 126 | 7,606 |
| 29 | 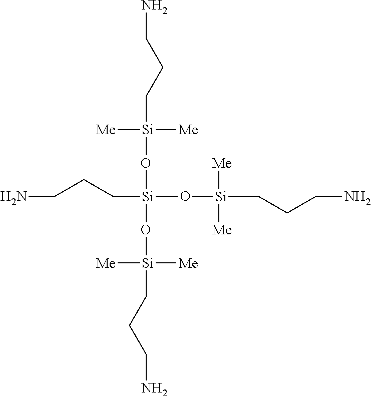 [SMILES: C[Si](C)(CCCN)O[Si](CCCN)(O[Si](C)(C)CCCN)O[Si](C)(C)CCCN] | 11.3 | 9.1 | 124 | 11,279 |

Table 5. listing Examples 30-36, provides data regarding CO₂ uptake and viscosity when using GAP-1 carbamate, in various ratios with N-methyldiethanolamine.

TABLE 5

| | | | | | Carbamate |
|---|---|---|---|---|---|
| | | | | | Solution |
| | Ratio of | CO₂ | CO₂ Uptake | CO₂ | Viscosity |
| | GAP-1 to N- | Uptake | (theoretical | Uptake (% | (cP @ |
| Ex. # | Methanolamine | (wt %) | wt %) | of theory) | 40° C.) |
| 30 | 20:80 | 5.1 | 2.7 | 188.9 | 131 |
| 31 | 30:70 | 6.4 | 4.1 | 156 | 235 |
| 32 | 40:60 | 7.2 | 5.4 | 133 | 449 |
| 33 | 50:50 | 8.8 | 6.8 | 129.1 | 946 |
| 34 | 60:40 | 9.1 | 8.2 | 111 | 1,885 |
| 35 | 70:30 | 11 | 9.5 | 115.8 | 4,883 |
| 36 | 80:20 | 12.2 | 10.9 | 112 | 16,224 |

Table 6. listing Examples 37-42, provides data regarding CO₂ uptake and viscosity when using GAP-1 carbamate, in various ratios with N,N-diethylproponalamine.

TABLE 6

| | Ratio of | | | CO₂ | Carbamate |
|---|---|---|---|---|---|
| | GAP-1 to | CO₂ | CO₂ Uptake | Uptake | Solution |
| | N-Diethyl | Uptake | (theoretical | (% of | Viscosity |
| Ex. # | propanolamine | (wt %) | wt %) | theory) | (cP @ 40° C.) |
| 37 | 20:80 | 2 | 2.7 | 74 | 16 |
| 38 | 30:70 | 3.8 | 4.1 | 93 | 64 |
| 39 | 40:60 | 5.9 | 5.4 | 109 | 216 |
| 40 | 50:50 | 7.5 | 6.8 | 110 | 423 |
| 41 | 60:40 | 8.8 | 8.2 | 107 | 1554 |
| 42 | 70:30 | 10.4 | 9.5 | 109 | 4959 |

Table 7. listing Examples 43-49, provides data regarding CO₂ uptake and viscosity when using GAP-1 carbamate, in various ratios with triethyleneglycol (TEG). These samples are for comparison with those of the present invention.

TABLE 7

| | | | | CO₂ | |
|---|---|---|---|---|---|
| | Ratio of | CO₂ | CO₂ Uptake | Uptake | Carbamate Solution |
| | GAP-1 to | Uptake | (theoretical | (% of | Viscosity (cP @ |
| Ex. # | TEG | (wt %) | wt %) | theory) | 40° C.) |
| 43 | 20:80 | 3.5 | 2.7 | 128 | 64 |
| 44 | 30:70 | 4.9 | 4.1 | 120 | 120 |
| 45 | 40:60 | 6.4 | 5.4 | 117 | 257 |
| 46 | 50:50 | 7.5 | 6.8 | 110 | 433 |
| 47 | 60:40 | 9.5 | 8.2 | 115 | 1292 |
| 48 | 70:30 | 10.6 | 9.5 | 111 | 3743 |
| 49 | 80:20 | 11.9 | 10.9 | 109 | 16173 |

A comparison of the data of Table 7 (comparative samples) and Table 5 (samples of the present invention) can reveal advantages in employing some of the modified siloxane/amino alcohol compositions. As an illustration, the samples of Table 5 can exhibit higher CO₂ uptake values at lower loadings of GAP-1, as compared to the analogous TEG-type samples of Table 7, while still maintaining a desirably low viscosity. The ability to achieve a good balance of viscosity and CO₂ uptake capacity while maintaining the siloxane constituent at relatively low levels is advantageous in some instances.

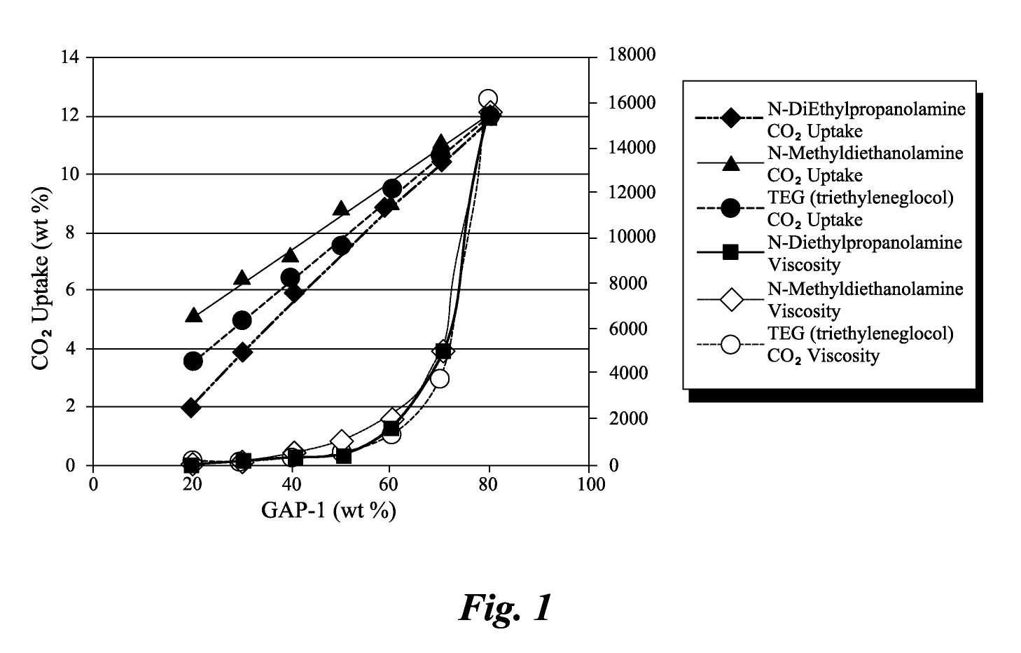

FIG. 1 is a graph depicting viscosity and CO₂ uptake as a function of weight % GAP-1 (1,5-bis-(3-aminopropyl)hexamethyl-trisiloxane) in N-diethylpropanolamine, N-methyldiethanolamine, and TEG (triethyleneglycol). The figure illustrates the linear relationship between CO₂ loading and the percentage of GAP-1 present, along with an exponential correlation with viscosity and GAP-1 content. The figure shows a very large viscosity increase, when exceeding about 60-70 wt % t of the GAP-1.

With continued reference to FIG. 1, it can be seen that, for a given ratio of GAP-1 to one of the listed co-solvents, the viscosities are very similar. However, in some embodiments, there is a clear advantage, in terms of CO₂ loading, when using N-methyldiethanolamine, at a GAP-1:co-solvent ratio of about 50% or lower.

The use of the amino alcohols may provide other advantages as well. For example, TEG and other glycol-type materials have been reported to thermally-decompose to some extent, at relatively low temperatures. It is expected that many of the amino alcohols may exhibit greater thermal stability.

While the invention has been described with reference to exemplary embodiments, it will be understood by those skilled in the art that various changes may be made, and equivalents may be substituted for elements thereof, without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A carbon dioxide absorbent, comprising
a) a liquid, non-aqueous, silicon-based material, functionalized with one or more groups that reversibly react with CO₂ and/or have a high-affinity for CO₂; and
b) at least one amino alcohol compound.

2. The carbon dioxide absorbent of claim 1, wherein the amino alcohol compound has a boiling point greater than about 90° C.

3. The carbon dioxide absorbent of claim 1, wherein the amino alcohol compound has a viscosity less than about 200 cP, at 40° C.

4. The carbon dioxide absorbent of claim 1, wherein the amino alcohol compound has the formula 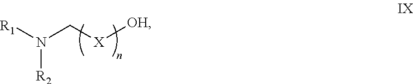
wherein X can be carbon (C), nitrogen (N), oxygen (O), sulfur (S), silicon (Si), or a linking group containing such an atom; and wherein n is 1 to 5 (and wherein all of the R groups are as defined below); 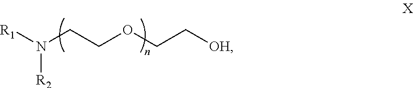
wherein n is 1 to 5; 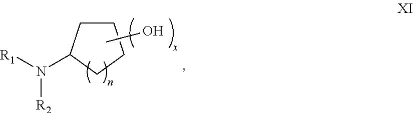
wherein n is 1 to 3; and x is 1 to 3; 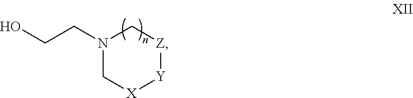
wherein X can be C, N, O, S, or Si; Y can be C, N, O, S, or Si; and Z can be C, N, O, S, or Si, or each of X, Y, or Z can be a linking group containing such atoms; and n is 0 to 3; 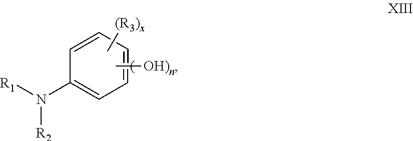
wherein n is 1 to 3; and x is 1 to 3; or 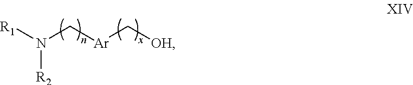
wherein n is 1 to 5; x is 0 to 3; and “Ar” is a phenyl group, cycloalkyl group, heterocycloalkyl group; or heteroaryl group; and
wherein, for each of formulae IX to XIV, R₁, R₂, and R₃ can be, independently, C₁-C₆ alkyl, C₂-C₆ alkenyl, C₃-C₇ cycloalkyl, phenyl, heterocycloalkyl; or a 5- or 6-membered heteroaryl group; or hydroxyl-substituted versions thereof.

5. The carbon dioxide absorbent of claim 1, wherein the amino alcohol compound has the formula 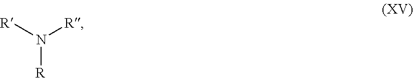
wherein each of R, R′, and R″ is independently hydrogen; a straight or branched chain aliphatic group containing about 2 to about 8 carbon atoms in a main chain; phenyl, cycloalkyl, heterocyclo alkyl, or heteroaryl;
but wherein at least one of R, R′, and R″ contains at least one hydroxy group.

6. The carbon dioxide absorbent of claim 5, wherein the amino alcohol compound of formula (XV) is a tertiary amine, in which each of R, R′, and R″ is an aliphatic group.

7. The carbon dioxide absorbent of claim 1, wherein the wherein the amino alcohol compound is selected from the group consisting of diethanolamine, triethanolamine, tripropanolamine, dimethylethanolamine, methyldiethanolamine, diethylethanolamine; di-(3-hydroxylpropyl)amine; N-tri(3-hydroxylbutyl)amine; N-tri-(4-hydroxylbutyl)amine; N,N-tri-(2-hydroxylpropyl)amine; N,N-diisopropylethanolamine; N,N-diethylpropanolamine; N,N-diethyl-(2,3-dihydroxypropyl)amine; N-ethyldiethanolamine; N-propyldiethanolamine, and combinations thereof.

8. The carbon dioxide absorbent of claim 1, wherein the functionalized, silicon-based material comprises compounds containing one or more siloxy units.

9. The carbon dioxide absorbent of claim 8, wherein the silicon-based material is functionalized with one or more nitrogen-containing groups.

10. The carbon dioxide absorbent of claim 9, wherein the functional group comprises a primary or secondary aliphatic or aromatic amine, imine, amidine, a heterocyclic amino compound, or combinations thereof.

11. The carbon dioxide absorbent of claim 10, wherein the functional group comprises at least one primary aliphatic amine or diamine, triamine, or polyamine.

12. The carbon dioxide absorbent of claim 11, wherein the functional group comprises aminomethyl, aminoethyl, aminopropyl, aminobutyl, aminoisobutyl, aminoethylaminopropyl; 4-methylaminobutyl; 4,4-dimethylaminobutyl; 3-(2-aminobutyl)aminopropyl; 2,2-bis(aminomethyl)butyl; 4,4-bis(aminomethyl)hexyl; 4,4-bis(aminomethyl)butyl; piperazinopropyl; aminoethylaminomethyl groups, or combinations of such groups.

13. The carbon dioxide absorbent of claim 8, wherein the functionalized, silicon-based material is selected from the group consisting of linear, branched, star or cyclic aminopropyl-, aminobutyl- or aminoisobutyl-substituted siloxanes.

14. The carbon dioxide absorbent of claim 1, wherein the ratio (by weight) of the functionalized silicon-based material (component (a)) to the amino alcohol (component (b)) is sufficient to provide a carbon dioxide absorbent that has a boiling point greater than about 90° C.; and a viscosity of less than about 10,000 cP, during at least one operating cycle in which the absorbent is used, wherein the temperature for the operating cycle is in a range of about 25° C. to about 200° C.

15. The carbon dioxide absorbent of claim 1, wherein the ratio (by weight) of the functionalized silicon-based material (component (a)) to the amino alcohol (component (b)) is in the range of about 20:80 to about 80:20.

16. The carbon dioxide absorbent of claim 1, wherein component (a) and component (b) are present as a physical mixture.

17. A method for reducing the amount of carbon dioxide in a process stream, comprising the step of contacting the stream with a carbon dioxide absorbent comprising
a) a liquid, non-aqueous, silicon-based material, functionalized with one or more groups that reversibly react with CO₂ and/or have a high-affinity for CO₂; and
b) at least one amino alcohol compound.

18. The method of claim 17, wherein the process stream comprises an exhaust gas stream from a combustion system, gasification system, or combination thereof.

19. A power plant comprising a carbon dioxide removal unit that contains a carbon dioxide absorbent that itself comprises:
a) a liquid, non-aqueous, silicon-based material, functionalized with one or more groups that reversibly react with CO₂ and/or have a high-affinity for CO₂; and
b) at least one amino alcohol compound.
